(19) United States
(12) Patent Application Publication
(10) Pub. No.: US 2013/0115424 A1
(43) Pub. Date: May 9, 2013

(54) PROCESS FOR PRODUCING POLYMER MEMBER WITH RUGGED SURFACE STRUCTURE, AND POLYMER MEMBER

(71) Applicants: Takafumi Hida, Ibaraki-shi (JP); Kunio Nagasaki, Ibaraki-shi (JP); Yusuke Sugino, Ibaraki-shi (JP); Kohei Doi, Ibaraki-shi (JP)

(72) Inventors: Takafumi Hida, Ibaraki-shi (JP); Kunio Nagasaki, Ibaraki-shi (JP); Yusuke Sugino, Ibaraki-shi (JP); Kohei Doi, Ibaraki-shi (JP)

(73) Assignee: NITTO DENKO CORPORATION, Ibaraki-shi, Osaka (JP)

(21) Appl. No.: 13/811,000

(22) PCT Filed: Jul. 28, 2011
(86) PCT No.: PCT/JP2011/067323

§ 371 Date: Jan. 18, 2013

(30) Foreign Application Priority Data
Jul. 30, 2010 (JP) 2010-172444

(51) Int. Cl. B32B 37/26

(52) U.S. Cl. CPC B32B 37/26
USPC 428/141; 156/307.1

(57) ABSTRACT

The purpose of the present invention is to provide a process for polymer member production in which a rugged surface structure is easy to control, and a polymer member obtained by the process. This process for producing a polymer member (10) having a rugged surface structure is characterized bar comprising a step (A) in which a monomer-absorbing layer (5) capable of absorbing a polymerizable monomer (2), a ruggedness transfer material layer (1) having a rugged surface (1a), and polymerizable-composition layer (4) containing the polymerizable monomer (2) are superposed so that the layer (4) is disposed between the monomer-absorbing layer (5) and the rugged surface (1a) of the transfer material layer (1) and a step (B) in which the polymerizable monomer (2) is polymerized. The process is further characterized in that the polymerizable-composition layer (4) contains an incompatible substance (3) which is incompatible with the polymerizable. monomer (2) and with the polymer to be obtained by polymerizing the polymerizable monomer, and that prior to the step (B), some of the polymerizable monomer (2) contained in the polymerizable-composition layer (4) is absorbed in the monomer-absorbing layer (5).

### TECHNICAL FIELD

The present invention relates to a process for producing a polymer member with a rugged surface structure, and a polymer member.

### BACKGROUND ART

A polymer member having a substance different from a main component forming of the member, which is unevenly distributed on its surface, is expected to be a member having new functions such as optical functions and electric functions. It is not easy, however, to form, for example, a layer having fine particles or a flame-retardant layer on a sheet or film, which is a substrate of a polymer member. For example, when a fine particle layer (a layer including fine particles) is formed on a substrate surface, after fine particles are dispersed in a solution in which a polymer component is dissolved in an organic solvent as a binder, the substrate is coated with the resulting dispersion, and then the organic solvent is volatilized by heat-drying to obtain that structure. This results in the ruggedness formed by the fine particles on the substrate surface. It is difficult, however, to apply this method to a case in which the substrate is dissolved in the organic solvent or a case in which the substrate is easily molten or deformed by the heat-drying due to its low heat-resistance. In addition, when the substrate surface has high adherability, such as a pressure-sensitive adhesive layer, it is difficult to coat the substrate surface with the dispersion in which the fine particles are dispersed described above. Furthermore, when the dispersion described above is used, the organic solvent must be dried, and even if an aqueous dispersion is used instead of the dispersion described above, the water must be dried. The method for forming the fine particle layer described above, therefore, is not preferable in terms of environment and energy saving. When the polymer component in the dispersion used for forming the fine particle layer described above is different from the material of the substrate, the fine particle layer may be peeled off from the substrate at the interface between them if the adhesion is insufficient.

The fine particle layer can be also formed on the substrate surface by forming a fine particle layer on a film to which releasing treatment has been subjected, and transferring it on a substrate sheet. When affinity or compatibility is low between the substrate and the fine particle layer, however, tackiness is poor between the substrate and the fine particle layer, and thus problems such as a peeling-off between layers easily occur. Moreover, when both the substrate and the fine particle layer have almost no tackiness, it is difficult to bond them together, and it becomes necessary to bond them together after either one or both of them are coated with an adhesive agent.

As a wallpaper for interior decoration used in a wide range of places including houses, hotels and public facilities, a wallpaper is generally used which is obtained by coating a base paper with a vinyl chloride resin, forming a foamable paste layer on the flame-resistant sheet, obtained by drying the above, by a printing process, and heating it to foam the foamable paste layer (see Patent Document 1, and the like). According to this method for producing the wallpaper, the foamable paste can be thickly coated by using a screen printing method or a gravure printing method in the printing of the foamable paste layer to realize expression of a voluminous rugged pattern. The use of a halogen-based resin such as the vinyl chloride resin used for the flame-resistant sheet described above, however, is becoming more and more restricted, in terms of a problem of generation of harmful gas when it is burned and a problem of generation of dioxin. It becomes difficult, therefore, to provide the flame-resistance to the wallpaper and further to provide the rugged pattern thereto.

The present inventors previously found that when a polymerizable composition layer including an incompatible substance which is incompatible with a polymerizable monomer and a polymer obtained by polymerization of the polymerizable monomer is formed on at least one surface of a monomer-absorbing layer capable of absorbing the polymerizable monomer, and the incompatible substance is moved in the polymerizable composition layer to obtain a polymerizable composition layer in which the incompatible substance is unevenly distributed, and then the polymerizable monomer described above is polymerized, a polymer member having a laminate structure of the polymer layer in which the incompatible substance is unevenly distributed and the monomer-absorbing layer can be obtained. It was also found that when particles are used as the incompatible substance, the ruggedness can be formed from the particles on an opposite side (outer surface) to the monomer-absorbing layer side of the polymer layer in which the incompatible substance is unevenly distributed (Patent Document 2).

### PRIOR ART DOCUMENTS

### Patent Documents

Patent Document 1: JP-A-7-132577

Patent Document 2: JP-A-2008-6817

### SUMMARY OF THE INVENTION

### Problems to be Solved by the Invention

According to the method described above, however, the rugged structure can be formed on the surface of the polymer layer in which the incompatible substance is unevenly distributed, but it is difficult to control the rugged structure such as shapes and sizes of protruded parts and depressed parts.

The present invention provides a process for producing a polymer member having a substance different from a main component forming of the member, which is unevenly distributed on the member surface, and having a rugged surface structure, wherein it is easy to control the rugged surface structure; and a polymer member obtained by the production process.

### Means for Solving the Problems

The present invention relates to a process for producing a polymer member with a rugged surface structure comprising:

the step A of laminating a monomer-absorbing layer capable of absorbing a polymerizable monomer, a ruggedness transfer material layer having a rugged surface, and a polymerizable composition layer including the polymerizable monomer so that the polymerizable composition layer is disposed between the monomer-absorbing layer and the rugged surface of the ruggedness transfer material layer, and the step B of polymerizing the polymerizable monomer, wherein

the polymerizable composition layer further includes an incompatible substance which is incompatible with the polymerizable monomer and a polymer obtained by polymerization of the polymerizable monomer, and

a part of the polymerizable monomers in the polymerizable composition layer are absorbed in the monomer-absorbing layer prior to performing the step B.

According to the process for producing a polymer member of the present invention, the incompatible substance, which is a substance different from a main component (base material component) forming of the member, can be unevenly distributed on the member surface, and moreover the incompatible substance can be moved toward the ruggedness transfer material layer side. The rugged structure, therefore, can be easily controlled on the member surface on which the incompatible substance is unevenly distributed. According to this process, for example, optical films on which regular (even) or irregular (uneven) ruggedness is formed for preventing the glare of a screen, and wallpapers to which flame-resistance and rugged patterns are provided can be easily formed.

The step A is preferably a step in which the rugged surface of the ruggedness transfer material layer is coated with a polymerizable composition including the polymerizable monomer and the incompatible substance to form the polymerizable composition layer, and then the monomer-absorbing layer is laminated on the polymerizable composition layer, because the rugged shape of the ruggedness transfer material layer can be transferred on the polymerizable composition layer with accuracy.

The step B is preferably a step in which both the polymerizable monomer in the polymerizable composition layer and the polymerizable monomer in the monomer-absorbing layer are polymerized, because the adhesion between the polymerizable composition layer and the monomer-absorbing layer can be improved after curing.

The rugged surface of the ruggedness transfer material layer has preferably an arithmetic mean roughness Ra of 0.007 μm or more and a maximum height roughness Rz of 0.036 μm or more. member obtained by the production process of the present invention described above. According to the polymer member of the present invention, the rugged structure can be easily controlled on the member surface on which the incompatible substance is unevenly distributed, for the same reasons as described above.

### BRIEF DESCRIPTION OF THE DRAWINGS

FIGS. 1A to 1D are cross-sectional views in each step, showing one example of a process for producing a polymer member of the present invention.

FIG. 2 is a scanning electron micrograph showing a surface layer cross-section and a rugged surface of an uneven distribution layer in a polymer sheet of Example 1.

FIG. 3 is a scanning electron micrograph showing a surface layer cross-section and a rugged surface of an uneven distribution layer in a polymer sheet of Example 2.

FIG. 4 is a scanning electron micrograph showing a surface layer cross-section of an uneven distribution layer in a polymer sheet of Example 3.

FIG. 5 is a scanning electron micrograph showing a surface layer cross-section of an uneven distribution layer in a polymer sheet of Comparative Example 1.

### MODE FOR CARRYING OUT THE INVENTION

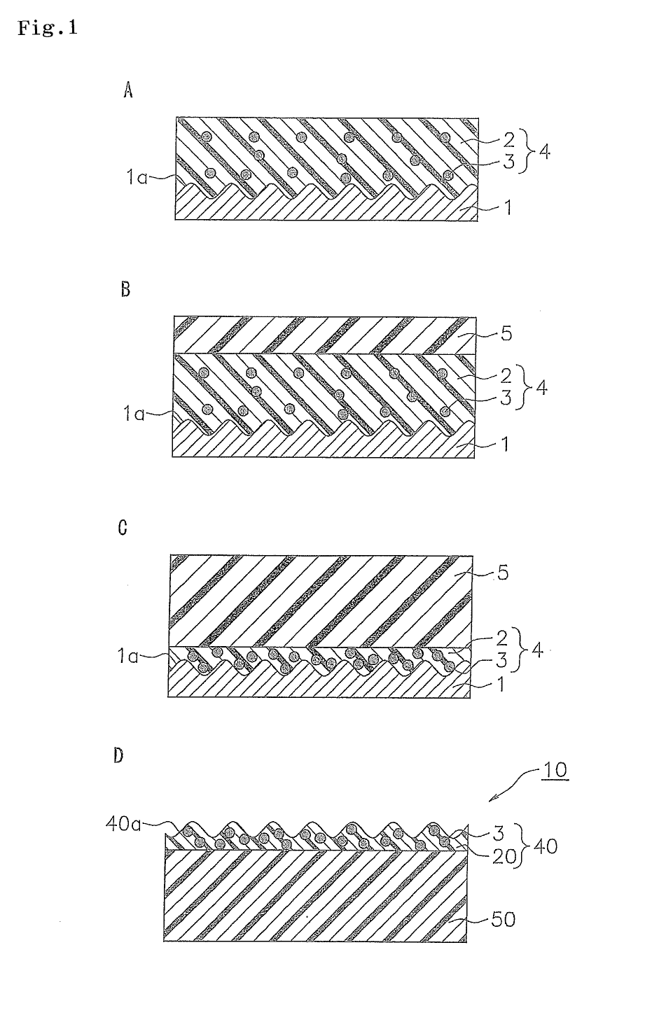

Referring to drawings, embodiments of the present invention will be explained below. FIGS. 1A to 1D referred are cross-sectional views in each step, showing one example of the process for producing a polymer member of the present invention.

First, as shown in FIG. 1A, a polymerizable composition layer 4 including a polymerizable monomer 2 and an incompatible substance 3 is formed on a ruggedness transfer material layer 1 with a rugged surface 1a. The method for forming the polymerizable composition layer 4 is not particularly limited, and may include a method in which a polymerizable composition (coating liquid) including the polymerizable monomer 2 and the incompatible substance 3 is prepared, and the resulting composition is coated on the ruggedness transfer material layer 1 using a common coater. The amount of the incompatible substance 3 in the coating liquid included is, for example, from about 0.1 to 200 parts by weight based on 100 parts by weight of the polymerizable monomer 2. The common coater may include a comma roll coater, a die roll coater, a gravure roll coater, a reverse roll coater, a kiss-roll coater, a dip roll coater, a bar coater, a knife coater, a spray coater, and the like. The polymerizable composition layer 4 has a thickness of, for example, about 1 to 1000 μm.

Next, a monomer-absorbing layer 5 capable of absorbing the polymerizable monomer 2 is formed on the polymerizable composition layer 4 (FIG. 1B). The method for forming the monomer-absorbing layer 5 is not particularly limited, and may include a method in which a monomer-absorbing sheet including a material capable of absorbing the polymerizable monomer 2 is previously formed, and the sheet is bonded to the polymerizable composition layer 4. The monomer-absorbing layer 5 has a thickness of, for example, about 1 to 1000 μm.

In this embodiment, the polymerizable composition layer 4 and the monomer-absorbing layer 5 are laminated in order on the ruggedness transfer material layer 1, but the present invention is riot limited thereto, and the polymerizable composition layer and the ruggedness transfer material layer may be laminated in order on the monomer-absorbing sheet. Alternatively, a sheet formed of a polymerizable composition is previously formed, and the sheet may be held between the monomer-absorbing sheet and the ruggedness transfer material layer (a mold, or the like). It is preferable, however, that the polymerizable composition layer 4 and the monomer-absorbing layer 5 are laminated in order on the ruggedness transfer material layer 1, as in the embodiment described above, to accurately transfer a ruggedness pattern of the ruggedness transfer material layer.

Subsequently, a part of the polymerizable monomers 2 in the polymerizable composition layer 4 are absorbed in the monomer-absorbing layer 5, and at the same time, as shown in FIG. 1C, the incompatible substance 3 is moved to the side of the ruggedness transfer material layer 1, whereby the incompatible substance 3 is unevenly distributed on the interface between the polymerizable composition layer 4 and the ruggedness transfer material layer 1 or the vicinity thereof (hereinafter this step is also referred to as an “uneven distribution step”).

In the uneven distribution step described above, the uneven distribution phenomenon of the incompatible substance 3 can be assumed to be caused by swelling of the monomer-absorbing layer 5. The monomer-absorbing layer 5 absorbs the polymerizable monomer 2 and swells; on the other hand, the incompatible substance 3 is absorbed in the monomer-absorbing layer 5 with difficulty. As a result, it can be considered that the incompatible substance 3 is unevenly distributed in the polymerizable composition layer 4 in the state in which the substance is left in the layer.

The uneven distribution phenomenon of the incompatible substance 3 advances, even if it is only allowed to stand at an ordinary temperature (for example at about 25° C.), after the monomer-absorbing layer 5 is laminated on the polymerizable composition layer 4. The uneven distribution step described above may be a step in which the laminate is allowed to stand at an ordinary temperature for about 1 to 180 minutes, preferably at an ordinary temperature for 30 to 60 minutes. In order to unevenly distribute the incompatible substance 3 in a high density, it is preferable that after the monomer-absorbing layer 5 is laminated on the polymerizable composition layer 4, the resulting laminate is heated at a temperature of more than 25° C. and 200° C. or less for one second to 120 minutes.

Subsequently, as shown in FIG. 1D, the polymerizable monomer 2 in the polymerizable composition layer 4 is polymerized to form a polymer 20, and the ruggedness transfer material layer 1 is peeled off, whereby a polymer member 10 having an uneven distribution layer 40 in which the incompatible substance 3 is unevenly distributed and a rugged surface 40a is obtained. When the polymerizable monomer 2 is polymerized, is preferable that the polymerizable monomer 2 in the monomer-absorbing layer 5 (FIG. 1C) is also polymerized to form a backing layer 50, because the adhesion between the monomer-absorbing layer 5 (i.e., the backing layer 50) and the uneven distribution layer 40 can be improved after the polymerization step. In order to polymerize both the polymerizable monomer 2 in the polymerizable composition layer 4 and the polymerizable monomer 2 in the monomer-absorbing layer 5, both the polymerizable composition layer 4 and the monomer-absorbing layer 5 may be formed from a light-permeable material in the case of photo-polymerization.

In the present invention, the polymerizable composition layer 4 after the polymerization of the polymerizable monomer 2 (i.e., the uneven distribution layer 40) includes the polymer 20 obtained by polymerization of the polymerizable monomer 2 in a content of, preferably 1% by weight or more, more preferably 5% by weight or more, in terms of the mechanical strength of the obtained polymer member 10. In order to easily and unevenly distribute the incompatible substance 3, the polymer 20 is included in a range of, preferably 30% by weight or less, more preferably 20% by weight or less. In order to control the polymer 20 in the uneven distribution layer 40 to the range described above, a time allowed for standing, after the monomer-absorbing layer 5 is laminated on the polymerizable composition layer 4, is regulated to control the amount of monomers absorbed in the monomer-absorbing layer 5.

When the polymerizable monomer 2 is polymerized by photo-polymerization, there are no particular limitations in a light source, irradiation energy, an irradiation method, an irradiation time, and the like, so long as the polymerizable monomer 2 can be polymerized and cured by photo-irradiation, thereby obtaining the uneven distribution layer 40. The active energy rays used in the photo-polymerization may include, for example, ionizing radiation such as α-rays, β-rays, γ-rays, neutron beams and electron rays, and ultra-violet rays. The ultra-violet rays are particularly preferable in terms of the production cost. The light source of the active energy rays may include, for example, a black light lamp, a chemical lamp, a high pressure mercury lamp, a metal-halide lamp, and the like.

The rugged surface 1a of the ruggedness transfer material layer 1 may have a peeling-off property or may not have the peeling-off property. In the present invention, the ruggedness transfer material layer 1 may be peeled off or may not be peeled off after the polymerization step of the polymerizable monomer 2. The method for providing the peeling-off property may include a method in which the ruggedness transfer material layer 1 is coated with a release treating agent (a peel-off treatment agent) such as a silicone-based releasing agent to form a release treatment layer is peel-off treatment layer), and a method in which the ruggedness transfer material layer 1 is formed from a low-tackiness material such as a fluorine-based polymer.

It is preferable to use a material which little permeates oxygen as a material for forming the ruggedness transfer material layer 1, in order to avoid inhibition of reaction caused by oxygen in the air, in a case in which the photo-polymerization is used in the polymerization step of the polymerizable monomer 2. When the photo-irradiation is performed from the ruggedness transfer material layer 1 side in the photo-polymerization, it is preferable to use a light-permeable material.

The material for forming the ruggedness transfer material layer 1 may specifically include low-tackiness materials formed of a fluorine-based polymer (for example, polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer, or the like); low-tackiness materials formed of a non-polar polymer (for example, an olefin-based resin such as polyethylene or polypropylene); plastic materials (synthetic resins) such as polyester including polyethylene terephthalate, polyvinyl chloride, polyimide, polyamide and rayon; papers (fine quality paper, Japanese paper, craft paper, glassine paper, synthetic paper, topcoat paper, and the like); sheets or laminated produced from these materials, multi-layered products obtained by co-extrusion of these materials (for example, laminates of two or three layers), and the like. In addition, a metal such stainless steel may be used. Of these, the plastic materials (in particular, polyethylene terephthalate) are preferable in terms of the light permeability.

The shape of the ruggedness transfer material layer 1 is not particularly limited so long as it has the rugged surface 1a, and various shapes including film-like, sheet-like or plate-like shapes can be used. The rugged surface 1a may be, for example, a rugged surface such as a pear skin finished, pebbling, matte, checked, diamond, grained, cross-grained, cubic rice cracker-shaped, hair line-shaped, plunging breaker-shaped, hexagonal, polka-dotted, arabesque, wavy or marble grained surface. The method for forming the rugged surface 1a may include a method in which the surface of the substrate formed from the material described above is subjected to an embossment, and the like. When a metal is used as the material for the ruggedness transfer material layer 1, resist patterns may be formed on the surface of the metal substrate by photolithography, and the ruggedness may be formed on the surface by etching. According to this method, a rugged surface 1a with an even rugged structure can be formed. When the obtained polymer member is used as a wallpaper, template (a mold) for forming a wallpaper pattern may be used for the ruggedness transfer material layer 1. The rugged surface 1a may be formed either on one side of the ruggedness transfer material layer 1 or on both sides thereof.

In the present invention, the ruggedness transfer material layer is a layer for providing a desired rugged shape on the polymer member, and does not include a layer with a smooth surface. Films having a surface shape with an arithmetic mean roughness Ra, in accordance with JIS B 0601:2001, of less than 0.007 μm and a maximum height roughness Rz, in accordance with JIS B 0601:2001, of less than 0.036 μm (for example, a polyethylene terephthalate film, “MRN 38” (trademark) manufactured by Mitsubishi Chemical Polyester Film Corporation), accordingly, are nor included. From the viewpoints described above, the rugged surface 1a of the ruggedness transfer material layer 1 has preferably an arithmetic mean roughness Ra of 0.007 μm or more and a maximum height roughness Rz of 0.036 μm or more. Both the arithmetic mean roughness Ra and the maximum height roughness Rz do not have preferable upper limits, but usually the arithmetic mean roughness Ra is 500 μm or less, and the maximum height roughness Rz is 1000 μm or less.

The polymerizable composition layer 4 includes the polymerizable monomer 2 which is polymerizable by light or heat, and the incompatible substance 3. In addition, the polymerizable composition layer 4 may also include a polymerization initiator such as a photo-polymerization initiator.

The polymerizable monomer 2 is a compound which is capable of polymerizing by utilizing light energy or heat energy, regardless of a reaction mechanism such as a radical polymerization or a cationic polymerization. Such a polymerizable monomer 2 may include, for example, radical polymerizable monomers such as acrylic-based monomers forming an acrylic-based polymer; cationic polymerizable monomers such as epoxy-based monomers forming an epoxy-based resin, oxetane-based monomers forming an oxetane-based resin, and vinyl ether-based monomers forming a vinyl ether-based resin; mixtures of a polyisocyanate and a polyol, which forms a urethane-based resin; mixtures of a polycarboxylic acid and a polyol, which forms a polyester-based resin, and the like. The polymerizable monomer 2 may be used alone or as a mixture of two or more kinds. Of these, the acrylic-based monomers are preferably used, because of fast polymerization speed and good productivity.

The acrylic-based polymer, the epoxy-based resin, the oxetane-based resin, the vinyl ether-based resin, the urethane-based resin, and the polyester-based resin described above may be respectively a base polymer of an acrylic-based pressure-sensitive adhesive (a pressure-sensitive adhesive), a base polymer of an epoxy-based pressure-sensitive adhesive, a base polymer of an oxetane-based pressure-sensitive adhesive, a base polymer of a vinyl ether-based pressure-sensitive adhesive, a base polymer of a urethane-based pressure-sensitive adhesive, and a base polymer of a polyester-based pressure-sensitive adhesive; in other words, the polymerizable composition layer 4 may be a pressure-sensitive adhesive composition layer. In the present invention, accordingly, the uneven distribution layer 40 formed by curing the polymerizable composition layer 4 (see FIG. 1D) may be a pressure-sensitive adhesive layer in which the incompatible substance 3 is unevenly distributed.

The “pressure-sensitive adhesive composition” described above refers to a “composition including a pressure-sensitive adhesive component.” For example, the polymerizable composition layer 4 including the polymerizable monomer 2, the particles (the incompatible substance 3) and the photo-polymerization initiator may be sometimes referred to as a “pressure-sensitive adhesive composition layer.” When the acrylic-based monomer, which is a preferable material as the polymerizable monomer 2, is used, therefore, the polymerizable composition layer 4 may be a particle-containing photo-polymerizable acrylic-based pressure-sensitive adhesive composition layer.

(Meth)acrylic acid alkyl esters having an alkyl group may be preferably used as the acrylic-based monomer. Of these, (meth)acrylic acid alkyl esters having an alkyl group with 2 to 14 carbon atoms are preferable, and (meth)acrylic acid alkyl ester having an alkyl group with 2 to 10 carbon atoms are more preferable. It is to be noted that, the above term “(meth)acrylic” expresses “acrylic” and/or “methacrylic”, and other related terms.

Both (meth)acrylic acid alkyl esters having a linear or branched alkyl group and (meth)acrylic acid alkyl esters having a cyclic alkyl group are preferably used as the (meth)acrylic acid alkyl ester having an alkyl group.

The (meth)acrylic acid alkyl ester having the linear or branched alkyl group may include, for example, (meth)acrylic acid alkyl esters having an alkyl group with 1 to 20 carbon atoms such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate.

The (meth)acrylic acid alkyl ester having the cyclic alkyl group may include, for example, cyclopentyl(meth)acrylate, cyclohexyl(meth)acrylate, isobornyl(meth)acrylate, and the like.

The acrylic-based monomer may be used alone or as a mixture of two or more kinds. The acrylic-based monomer described above is a component mainly used in the acrylic-based polymer (a main monomer component.) The monomer ratio of the acrylic-based monomer (a content in the monomer component) is, for example, preferably 60% by weight or more to the total amount of the monomer component forming the acrylic-based polymer, more preferably 80% by weight or more; that is, the acrylic-based monomer is included in a content of preferably 60% by weight or more to the total amount of the polymerizable monomer 2, more preferably 80% by weight or more.

Various copolymerizable monomers such as a polar group-containing monomer or a polyfunctional monomer may also be used as the polymerizable monomer 2. For example, when the polymerizable composition layer 4 is an incompatible substance-containing acrylic-based polymerizable composition layer (an incompatible substance-containing acrylic-based pressure-sensitive adhesive composition layer), the use of the copolymerizable monomer as one component of the polymerizable monomer 2 can improve, for example, adhering strength of the incompatible substance-containing acrylic-based pressure-sensitive adhesive composition layer to an adherend, or can enhance cohesive strength of the polymer layer. The copolymerizable monomer may be used alone or as a mixture of two or more kinds.

The polar group-containing monomer described above may include, for example, carboxyl group-containing monomers such as (meth)acrylic acid, itaconic acid, maleic acid, fumaric acid, crotonic acid and isocrotonic acid, or anhydrides thereof (maleic anhydride, and the like); hydroxyl group-containing monomers including hydroxyalkyl(meth)acrylate such as hydroxylethyl(meth)acrylate, hydroxypropyl(meth)acrylate and hydroxybutyl(meth)acrylate, vinyl alcohol, and allyl alcohol; amide group-containing monomers such as (meth)acrylamide, N,N-dimethyl(meth)acrylamide, N-methylol(meth)acrylamide, N-methoxymethyl(meth)acrylamide, and N-butoxymethyl(meth)acrylamide; amino group-containing monomers such as aminoethyl(meth)acrylate, dimethylaminoethyl(meth)acrylate, and t-butylaminoethyl(meth)acrylate; glycidyl group-containing monomers such as glycidyl(meth)acrylate, and methylglycidyl(meth)acrylate; cyano group-containing monomers such as acrylonitrile and methacrylonitrile; heterocyclic group-containing vinyl-based monomers such as N-vinyl-2-pyrrolidone(meth)acryloyl morpholine, N-vinyl pyridine, N-vinyl piperidone, N-vinyl pyrimidine, N-vinyl piperazine, N-vinyl pyrrole, N-vinyl imidazole, and N-vinyl oxazole; alkoxyalkyl(meth)acrylate monomers such as methoxyethyl(meth)acrylate and ethoxyethyl(meth)acrylate; sultanate group-containing monomers such as sodium vinylsulfonate; phosphate group-containing monomers such as 2-hydroxyethylacryloyl phosphate; imide group-containing monomers such as cyclohexyl maleimide and isopropyl maleimide; isocyante group-containing monomers such as 2-methacryloyloxyethyl isocyanate, and the like. Of these, the carboxyl group-containing monomer and the anhydride thereof are preferable, and acrylic acid is particularly preferable.

The polyfunctional monomer described above may include, for example, hexanediol di(meth)acrylate, butanediol di(meth)acrylate, (poly)ethyleneglycol di(meth)acrylate, (poly)propyleneglycol di(meth)acrylate neopentylglycol di(meth)acrylate, pentaerythritol di(meth)acrylate, pentaerythritol tri(meth)acrylate, dipentaaerythritol hexa(meth)acrylate, trimethylolpropane tri(meth)acrylate, tetramethylolmethane tri(meth)acrylate, allyl(meth)acrylate, vinyl(meth)acrylate, divinyl benzene, epoxyacrylate, polyester acrylate, urethane acrylate, N,N-methylene bisacrylamide, and the like.

As described above, the polymerizable composition layer 4 may include the polymerization initiator. When the polymerization initiator is used, the incompatible substance 3 is maintained in the state in which the substance is unevenly distributed and thus the polymerizable composition layer 4 can be easily cured at the time when the polymerizable monomer 2 is polymerized after the uneven distribution step. In the present invention, a curing reaction using active energy rays in which a photo-polymerization initiator (a light initiator) is used, is preferably utilized as the method for polymerizing the polymerizable monomer 2, because the state in which the incompatible substance 3 is unevenly distributed can be more easily maintained.

The photo-polymerization initiator is not particularly limited, and, for example, a benzoinether-based photo-polymerization initiator, an acetophenone-based photo-polymerization initiator, an α-ketol-based photo-polymerization initiator, an aromatic sulfonyl chloride-based photo-polymerization initiator, a photoactive oxime-based photo-polymerization initiator, a benzoin-based photo-polymerization initiator, a benzyl-based photo-polymerization initiator, a benzophenone-based photo-polymerization initiator, a ketal-based photo-polymerization initiator, an acyl phosphine oxide-based photo-polymerization initiator, a thioxanthone-based photo-polymerization initiator, and the like, may be used. The photo-polymerization initiator may be used alone or as a mixture of two or more kinds.

Specifically, the benzoinether-based photo-polymerization initiator may include, for example, benzoin methyl ether, benzoin ethyl ether, benzoin propyl ether, benzoin isopropyl ether, benzoin isobutyl ether, and the like. The acetophenone-based photo-polymerization initiator may include, for example, 1-hydroxycyclohexyl phenyl ketone [for example, the trademark “Irgacure 184” (manufactured by Ciba Specialty Chemicals Inc.), and the like], 2,2-diethoxyacetophenone, 2,2-dimethoxy-2-phenyl acetophenone, 4-phenoxydichloroacetophenone, 4-(t-butyl)dichloroacetophenone, and the like. The α-ketol-based photo-polymerization initiator may include, for example, 2-methyl-2-hydroxypropiophenone, 1-[4-(2-hydroxyethyl)phenyl]-2-methylpropan-1-one, and the like. The aromatic sulfonyl chloride-based photo-polymerization initiator may include, for example, 2-naphthalenesufonyl chloride, and the like. The photoactive oxime-based photo-polymerization initiator may include, for example, 1-phenyl-1,1-propanedione-2-(o-ethoxycarbonyl)-oxime, and the like. The benzoin-based photo-polymerization initiator may include, for example, benzoin, and the like. The benzyl-based photo-polymerization initiator may include, for example, benzil, and the like. The benzophenone-based photo-polymerization initiator may include, for example, benzophenone, benzoylbenzoic acid, 3,3′-dimethyl-4-methoxybenzophenone, polyvinyl benzophenone, α-hydroxycyclohexyl phenyl ketone, and the like. The ketal-based photo-polymerization initiator may include, for example, 2,2-dimethoxy-1,2-diphenylethane-1-one [for example, the trademark “Irgacure 651” (manufactured by Ciba, Specialty Chemicals Inc.), and the like] and the like. The acyl phosphine oxide-based photo-polymerization initiator may include, for example, the trademark “Lucirin TPO” (manufactured by BASF Ltd.), and the like. The thioxanthone photo-polymerization initiator may include, for example, thioxanthone, 2-chlorothioxanthone, 2-methyl thioxanthone, 2,4-dimethyl thioxanthone, isopropyl thioxanthone, 2,4-diisopropyl thioxanthone, dodecyl thioxanthone, and the like.

The amount of the photo-polymerization initiator used is not particularly limited, and it is within a range of, for example, 0.01 to 5 parts by weight (preferably 0.05 to 3 parts by weight) based on 100 parts by weight of the polymerizable monomer 2.

The incompatible substance 3 is not particularly limited so long as it is a substance incompatible with the polymerizable monomer 2 and the polymer 20 obtained by the polymerization of the polymerizable monomer 2, and may be either an inorganic substance or an organic substance. In order to easily perform the uneven distribution of the incompatible substance 3 in the uneven distribution step, a substance insoluble in the monomer-absorbing layer 5 is preferable. In addition, the incompatible substance 3 may be either a solid such as a particle (a fine particle, a fine particle powder) or a substance with fluidity.

The determination whether or not some substance is an incompatible substance with a polymerizable monomer and a polymer obtained by polymerization of a polymerizable monomer can be performed by the determination of how big the aggregates of the substance above are when dispersed in the polymerizable monomer or the polymer obtained by the polymerization of the polymerizable monomer, by visual observation, by using an optical microscope, a scanning electron microscope (SEM), a transmission electron microscope (TEM) an X-ray diffraction, or the like. For example, a state, in which the substance above is dissolved in the polymerizable monomer, and the polymerizable monomer is polymerized to obtain a polymer, may be determined; a state, in which the polymer obtained by the polymerization of the polymerizable monomer is dissolved in a solvent, then the substance above is added thereto, and, after the mixture is stirred, the solvent is removed therefrom, may be determined; or if the polymer obtained by the polymerization of the polymerizable monomer is a thermoplastic polymer, a state, in which the polymer is heated and dissolved, to which the substance is added, and the mixture is cooled, may be determined. The evaluation criteria are as follows: when the substance or its aggregate has a form which can be approximated to a sphere including a sphere, a cube, or an indeterminate form, a substance having a diameter (a maximum diameter) of 5 nm or more can be determined to be an incompatible substance. When the substance or its aggregate has a form which can be approximated to a cylinder including a bar, a thin layer, or a rectangular parallelepiped, a substance having a longest side of 10 nm or more can be determined to be an incompatible substance.

When the inorganic substance is used as the incompatible substance 3, an inorganic substance including, for example, clay mineral such as silica, calcium carbonate, clay, titanium oxide, talc, lamellar silicate and lamellar clay mineral; metals (for example, nickel, aluminum, iron, magnesium, copper, and the like), barium titanate, boron nitride, silicon nitride, aluminum nitride, glass, glass beads, glass balloon, alumina balloon, ceramic balloon, titanium while and carbon black, may be used.

The lamellar clay mineral described above may include, for example, smectite such as montmorillonite, beidellite, hectorite, saponite, nontronite and stevensite; mica; vermiculite; bentonite; lamellar sodium silicate such as kanemite, kenyaite and makatite. Such lamellar clay mineral may be either a naturally generated mineral or a mineral produced by a chemical synthesis. The lamellar clay mineral can be used as an agent for giving flame-resistance. In this case, the obtained polymer member can be used as, for example, a wallpaper having flame-resistance on its surface.

When the organic substance is used as the incompatible substance 3, an organic substance including, for example, polymers and oligomers thereof such as acrylic-based polymers, polyesters, polyurethanes, polyethers, fluorene derivative compounds, silicone, natural rubber, synthetic rubber [in particular, synthetic rubber including a styrene component such as styrene-isoprene-styrene rubber (SIS), styrene-isobutylene-styrene rubber (SIBS), styrene-butadiene-styrene rubber (SBS), and styrene-ethylene-butylene-styrene rubber (SEBS)]; tackifiers (tackifier resins) such as rosin-based tackifier resins, terpene-based tackifier resins, phenol-based tackifier resins, hydrocarbon-based tackifier resins, ketone-based tackifier resins, polyamides based tackifier resins, epoxy-based tackifier resins, and elastomer-based tackifier resins, may be used.

In addition, as the incompatible substance 3, surfactants, antioxidants, organic pigments, plasticizers, or liquid such as solvent (organic solvents), water and aqueous solutions (aqueous solutions of a salt and aqueous solutions of an acid, and the like), may be used.

When the particle is used as the incompatible substance 3, for example, inorganic particles formed of the inorganic substance recited above; organic particles such as polyester beads, nylon beads, silicon beads, urethane beads, vinylidene chloride beads and acrylic balloon; resin particles such as cross-linked acrylic particles, cross-linked styrene particles, melamine resin particles, benzoguanamine resin particles and polyamide resin particles; inorganic-organic hybrid particles, may be used. The particle may include any of a solid body and a hollow body (balloon). The particle may be used alone or as a mixture of two or more kinds.

The monomer-absorbing layer 5 has a monomer-absorbing plane which can absorb at least one monomer used as the polymerizable monomer 2. Needless to say, the whole monomer-absorbing layer 5 may be formed of the material capable of absorbing at least one monomer described above. As the monomer-absorbing layer 5, for example, a monomer-absorbing sheet formed by using a material capable of absorbing at least one monomer described above, may be used.

The monomer-absorbing sheet may include, for example, a substrate-less monomer-absorbing sheet which is formed of only the material capable of absorbing at least one monomer described above; and a substrate-attached monomer-absorbing sheet in which a layer formed of the material capable of absorbing at least one monomer described above (a monomer-absorbing material layer) is formed on a substrate. When the monomer-absorbing sheet is the substrate-less monomer-absorbing sheet, the monomer-absorbing plane may be any face of the sheet. On the other hand, when it is the substrate-attached monomer-absorbing sheet, the monomer-absorbing plane is the surface of the monomer-absorbing material layer.

The material for the substrate-less monomer-absorbing sheet or the monomer-absorbing material layer may include, for example, paper sheets (craft paper, crepe paper, Japanese paper, and the like); fiber sheets (a cloth, unwoven fabric, a net, and the like); porous films; polymers (acrylic-based polymers, polyurethane resins, ethylene-vinyl acetate copolymers, epoxy resins, and the like); natural rubber; synthetic rubber, and the like. The forming material may be used alone or as a mixture of two or more kinds.

As for the monomer-absorbing layer 5, its elastic modulus is not also particularly limited so long as the layer can absorb at least one monomer used as the polymerizable monomer 2. As the monomer-absorbing layer 5, accordingly, either a layer having a low elastic modulus such as a pressure-sensitive adhesive layer or a polymer layer or a layer having a high elastic modulus such as a plastic sheet, a hard-coating layer or a colored coating film layer may be used.

In the present invention, polymers can be preferably used as a material for forming the monomer-absorbing layer 5, because they have a high affinity with the polymerizable monomer 2 and a fast absorption rate; in other words, a monomer-absorbing material layer formed of a polymer can be preferably used as the monomer-absorbing layer 5. In addition, a sheet including a polymer can be preferably used as the monomer-absorbing sheet.

The polymer which can be used for the monomer-absorbing layer 5 is not particularly limited. When an incompatible substance-containing acrylic-based polymerizable composition layer is used as the polymerizable composition layer 4 for example, acrylic-based polymers are preferable as the polymer forming the monomer-absorbing layer 5.

The monomer-absorbing layer 5 may be formed from a polymer obtained by polymerization of a polymerizable composition forming the polymerizable composition layer 4 from which only the incompatible substance 3 is removed.

When the substrate-attached plastic monomer-absorbing sheet is used, a plastic substrate to be used may be subjected to an extension treatment, whereby deformation such as an elongation percentage is controlled. When the monomer-absorbing material layer is cured by active energy rays, it is preferable to use a substrate which does not hinder the permeation of the active energy rays for the substrate of the substrate-attached monomer-absorbing sheet. In order to improve the adhesion between the substrate surface of the substrate-attached monomer-absorbing sheet and the monomer-absorbing material layer, the substrate surface may be subjected to a common surface treatment such as a corona treatment, chromic acid treatment, exposure to ozone, exposure to a flame, exposure to high pressure electric shock, an oxidation treatment by a chemical or physical method such as an ionizing radiation treatment, or the like, and may also be subjected to a coating treatment using a priming agent or releasing agent.

In the polymer member 10 obtained in the present invention, the rugged shape of the surface can be easily controlled, and therefore, the polymer member can be used on a surface of a display as an anti-glare film which prevents glare by scattering incident light, or an anti-reflection film which inhibits reflection. It can also be used for an indoor wallpaper having the flame-resistance and the rugged pattern.

### EXAMPLES

Examples of the present invention will be explained together with Comparative Example below, but the present invention should not be understood to be limited to Examples described below. In Examples and Comparative Example, physical properties were evaluated by methods described below.

### <Measurement Method of Surface Roughness>

An arithmetic mean roughness Ra and a maximum height roughness Rz were measured for a rugged surface of a ruggedness transfer material or a polymer sheet using a high brightness non-contact three-dimensional surface roughness meter (Wyko NT 9100 manufactured by Japan Veeco Co., Ltd) in accordance with JIS B 0601: 2001. The measurement was performed at a magnification of 5.7 times.

### <Method of Cross-Sectional Observation>

A cross-sectional observation of a polymer sheet was performed using a scanning electron microscope (S-3400 N type manufactured by Hitachi High-Tech Fielding Corporation).

### <Measurement Method of HAZE>

A HAZE value and a total light transmittance of a rugged surface of a polymer sheet, which was as a surface to be measured (a light incident surface) were measured using HAZEMETER (HM-150 manufactured by Murakami Color Research Laboratory Co, Ltd.).

### (Cover Film)

As a cover film, a biaxially stretched polyethylene terephthalate film (the trademark “MRN 38” manufactured by Mitsubishi Chemical Polyester Film Corporation) having thickness of 38 μm, whose one side was subjected to a release treatment with a silicone-based releasing agent, was used.

### (Paper Separator A)

A paper separator whose surface was treated with a silicone-based releasing agent and subjected to an emboss processing (an arithmetic mean roughness Ra: 3.9 μm, and a maximum height roughness Rz: 23.0 μm) was used as paper separator A.

### (Paper Separator B)

A paper separator whose surface was treated with a silicone-based releasing agent and subjected to an emboss processing (arithmetic mean roughness Ra: 12.6 μm and a maximum height roughness Rz: 75.0 μm) was used as paper separator B.

### (Mold)

A pressed metal described in JP-A-2004-226431 (a diameter of a depression part: 100 μm, a pitch of a depression part: 250 μm, a depth of a depression part: 10 μm, an arithmetic mean roughness Ra: 1.34 μm, a maximum height roughness Rz: 4.35 μm) was used as a mold.

### (Production of Substrate-Attached Monomer-Absorbing Sheet A)

After 100 parts by weight of cyclohexyl acrylate as a monomer component, 0.1 parts by weight of a photo-polymerization initiator (the trademark “Irgacure 651” manufactured by Ciba Specialty Chemicals Inc.), and 0.1 parts by weight of a photo-polymerization initiator (the trademark “Irgacure 184” manufactured by Ciba Specialty Chemicals Inc.) were stirred in a four-necked separable flask equipped with a stirrer, a thermometer, a nitrogen-introducing tube and a cooling tube until the mixture became uniform, the mixture was bubbled with nitrogen gas for one hour to remove dissolved oxygen. After that, ultraviolet rays were irradiated from the outside of the flask using a black light lamp to polymerize the monomer, and the lamp was turned off at the time a desired viscosity was obtained and the nitrogen-blowing was stopped to obtain a partial polymerization composition in which a part of the monomers were polymerized (a rate of polymerization of 7%).

One side of a biaxially stretched polyethylene terephthalate film having a thickness of 38 μm was coated with a photo-polymerizable syrup composition in which 0.1 parts by weight of 1,6-hexanediol diacrylate was uniformly mixed with 100 parts by weight of the obtained partial polymerization composition so that a film thickness was 100 μm after curing, thereby forming a photo-polymerizable syrup composition layer. Then, the cover film described above was bonded to the layer so that the surface to which the release treatment was subjected was brought into contact with the layer, and ultraviolet rays (an intensity of illumination: 5 mW/cm²) were irradiated for 3 minutes from the cover film side using a black light and cured the layer to form a monomer-absorbing material layer, thus producing a substrate-attached monomer-absorbing sheet A whose monomer-absorbing material layer surface was protected with the cover film. The rate of polymerization of the partial polymerization composition was obtained from the change in the weight of the composition before and after removal of the remaining monomer. The remaining monomer was removed by drying the composition in an oven having a temperature of 130° C. for 2 hours.

### (Preparation of Incompatible Substance-Containing Polymerizable Composition A)

An incompatible substance-containing polymerizable composition A was obtained by uniformly mixing 30 parts by weight of lamellar clay mineral (the trademark “SPN” manufactured by Co-op Chemical Co., Ltd.), 100 parts by weight of cyclohexyl acrylate (CHA), 1 part by weight of a photo-polymerization initiator (the trademark “Irgacure 651” manufactured by Ciba Specialty Chemicals Inc.), 1 part by weight of a photo-polymerization initiator (the trademark “Irgacure 184” manufactured by Ciba Specialty Chemicals Inc.), and 0.1 parts by weight of 1,6-hexanediol diacrylate.

### (Preparation of Incompatible Substance-Containing Polymerizable Composition B)

An incompatible substance-containing polymerizable composition B was obtained by uniformly mixing 100 parts by weight of a fluorene derivative, which was a high refractive index material, (the trademark “Ogsol EA-0200” manufactured by Osaka Gas Chemicals Co., Ltd.), 25 parts by weight of 2-ethylhexyl acrylate, 1 part by weight of a photo-polymerization initiator (the trademark “Irgacure 651” manufactured by Ciba Specialty Chemicals Inc.), 1 part by weight of a photo-polymerization initiator (the trademark “Irgacure 184” manufactured by Ciba Specialty Chemicals Inc.), and 0.1 parts by weight of 1,6-hexanediol diacrylate.

### Example 1

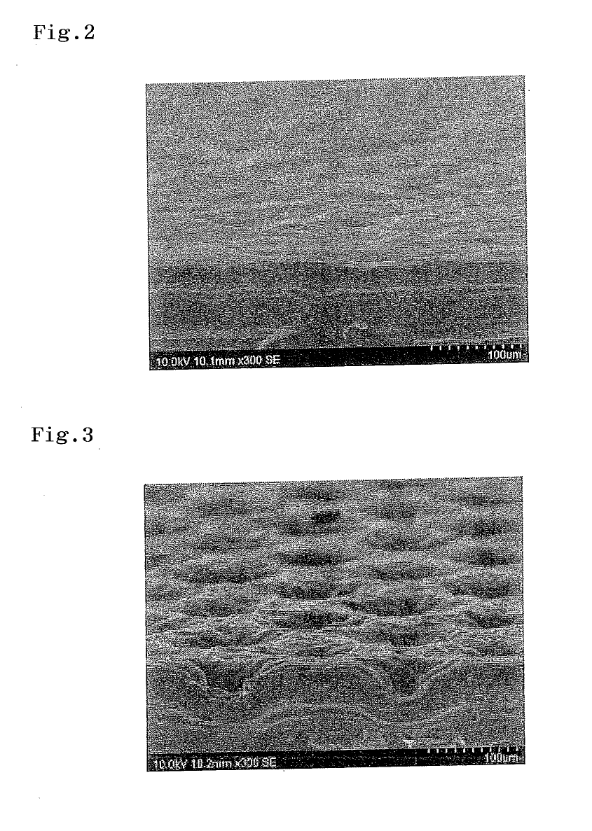

The incompatible substance-containing polymerizable composition A was coated on the paper separator A using a coater to form an incompatible substance-containing polymerizable composition layer having a thickness of 50 μm. After that, the monomer-absorbing material layer side of the substrate-attached monomer-absorbing sheet A from which the cover film had been removed, was bonded to the it substance-containing polymerizable composition layer. The laminate was allowed to stand at 25° C. for 5 minutes (the uneven distribution step), and then ultraviolet rays (an intensity of illumination: 5 mW/cm²) were irradiated for 10 minutes from the substrate-attached monomer-absorbing sheet A side using a black light. The paper separator A was removed to obtain a polymer sheet with a rugged structure on its surface. A scanning electron micrograph of the cross-section of the surface layer and the rugged surface of the uneven distribution layer in the polymer sheet of Example 1 is shown in FIG. 2.

### Example 2

The incompatible substance-containing polymerizable composition A was coated on the paper separator B using a coater to form an incompatible substance-containing polymerizable composition layer having a thickness of 50 μm. After that, the monomer-absorbing material layer side of the substrate-attached monomer-absorbing sheet A from which the cover film had been removed, was bonded to the incompatible substance-containing polymerizable composition layer. The laminate was allowed to stand at 25° C. for 5 minutes (the uneven distribution step), and then ultraviolet rays (an intensity of illumination: 5 mW/cm²) were irradiated for 10 minutes from the substrate-attached monomer-absorbing sheet A side using a black light. The paper separator B was removed to obtain a polymer sheet with a rugged structure on its surface. A scanning electron micrograph of the cross-section of the surface layer and the rugged surface of the uneven distribution layer in the polymer sheet of Example 2 is shown in FIG. 3.

### Example 3

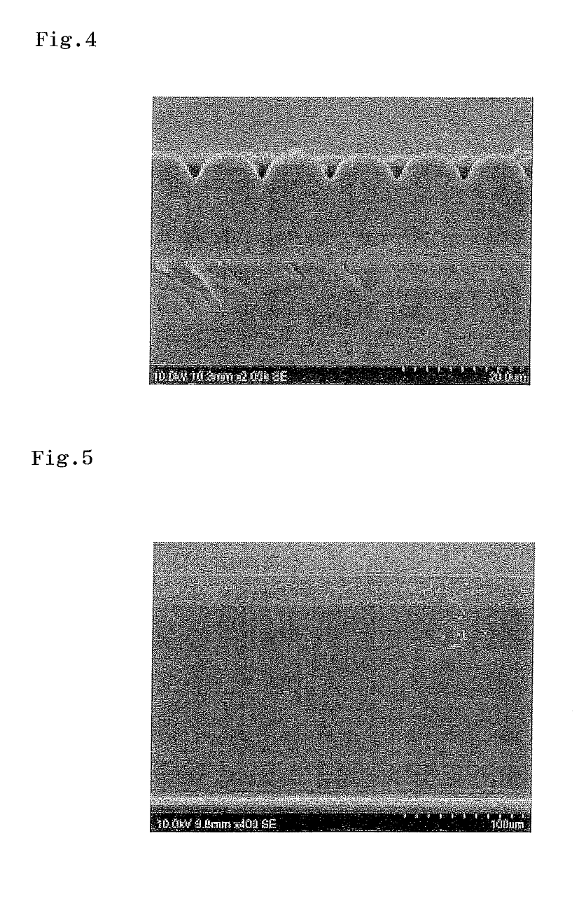

The incompatible substance-containing polymerizable composition B was coated on the mold described above using a coater to form an incompatible substance-containing polymerizable composition layer having a thickness of 50 μm. After that, the monomer-absorbing material layer side of the substrate-attached monomer-absorbing sheet A from which the cover film had been removed, was bonded to the incompatible substance-containing polymerizable composition layer. The laminate was allowed to stand at 25° C. for 5 minutes (the uneven distribution step), and then ultraviolet rays (an intensity of illumination: 5 mW/cm²) were irradiated for 10 minutes from the substrate-attached monomer-absorbing sheet A side using a black light. The mold was removed to obtain a polymer sheet with a rugged structure on its surface. A scanning electron micrograph of the cross-section of the surface layer of the uneven distribution layer in the polymer sheet of Example 3 is shown in FIG. 4.

### Comparative Example 1

The incompatible substance-containing polymerizable composition. A was coated on a polyethylene terephthalate film manufactured by Mitsubishi Chemical Polyester Film Corporation (the trademark “MRN 38”, an arithmetic mean roughness Ra: 0.006 μm, and a maximum height roughness Rz: 0.035 μm) using a coater to form an incompatible substance-containing polymerizable composition layer having a thickness of 50 μm. After that, the monomer-absorbing material layer side of the substrate-attached monomer-absorbing sheet A from which the cover film had been removed, was bonded to the incompatible substance-containing polymerizable composition layer. The laminate was allowed to stand at 25° C. for 5 minutes (the uneven distribution step), and then ultraviolet rays (an intensity of illumination: 5 mW/cm²) were irradiated for 10 minutes from the substrate-attached monomer-absorbing sheet A side using a black light. The polyethylene terephthalate film was removed to obtain a polymer sheet of Comparative Example 1. A scanning electron micrograph of the cross-section of the surface layer of the uneven distribution layer in the polymer sheet of Comparative Example 1 is shown in FIG. 5.

The evaluations described above were performed for the polymer sheets in Examples and Comparative Example. The results are shown in Table 1.

TABLE 1

| | | Example | Example | Example | Comparative |
|---|---|---|---|---|---|
| | | 1 | 2 | 3 | Example 1 |
| Optical | HAZE (%) | 62.6 | 87.5 | 94.7 | 2.1 |
| Evaluation | Transmit- | 90.4 | 92.4 | 92.1 | 92.2 |
| | tance (%) | | | | |
| Evaluation of | Ra (μm) | 2.11 | 8.56 | 0.94 | 0.005 |
| Roughness | Rz (μm) | 19.81 | 74.42 | 7.00 | 0.021 |
| in Uneven | | | | | |
| Distribution | | | | | |
| Layer | | | | | |

### DESCRIPTION OF REFERENCE SIGNS

1: ruggedness transfer material layer
1a: rugged surface
2: polymerizable monomer
3: incompatible substance
4: polymerizable composition layer
5: monomer-absorbing layer
10: polymer member
20: polymer
40: uneven distribution layer
40a: rugged surface
50: backing layer

1. A process for producing a polymer member with a rugged surface structure comprising:
the step A of laminating a monomer-absorbing layer capable of absorbing a polymerizable monomer, a ruggedness transfer material layer having a rugged surface, and a polymerizable composition layer including the polymerizable monomer so that the polymerizable composition layer is disposed between the monomer-absorbing layer and the rugged surface of the ruggedness transfer material layer; and
the step B of polymerizing the polymerizable monomer, wherein
the polymerizable composition layer further includes an incompatible substance which is incompatible with the polymerizable monomer and a polymer obtained by polymerization of the polymerizable monomer, and
a part of the polymerizable monomers in the polymerizable composition layer are absorbed in the monomer-absorbing layer prior to performing the step B.

2. The process for producing a polymer member according to claim 1, wherein the step A is a step in which the rugged surface of the ruggedness transfer material layer is coated with a polymerizable composition including the polymerizable monomer and the incompatible substance to form the polymerizable composition layer, and then the monomer-absorbing layer is laminated on the polymerizable composition layer.

3. The process for producing a polymer member according to claim 1, wherein the step B is a step in which both the polymerizable monomer in the polymerizable composition layer and the polymerizable monomer in the monomer-absorbing layer are polymerized.

4. The process for producing a polymer member according to claim 1, wherein the rugged surface of the ruggedness transfer material layer has an arithmetic mean roughness Ra of 0.007 μm or more and a maximum height roughness Rz of 0.036 μm or more.

5. A polymer member obtained by a production process according to claim 1.
